(19) United States
(12) Patent Application Publication
(10) Pub. No.: US 2024/0030716 A1
(43) Pub. Date: Jan. 25, 2024

(54) SYSTEMS AND METHODS FOR OVERLOAD CONTROL IN RENEWABLE POWER SYSTEMS

(71) Applicant: GE Grid GmbH, Frankfurt Am Main (DE)

(72) Inventors: Maozhong Gong, Niskayuna, NY (US); Hanchao Liu, Niskayuna, NY (US); Philip Joseph Hart, Burnt Hills, NY (US); Zhe Chen, Schenectady, NY (US)

(21) Appl. No.: 17/870,472

(22) Filed: Jul. 21, 2022

(51) Int. Cl. H02J 3/38; H02J 3/32; H02M 7/537; G05B 9/02

(52) U.S. Cl. CPC H02J 3/381; H02J 3/388; H02J 3/32; H02M 7/537; G05B 9/02; H02J 2300/28; H02J 2300/24

(57) ABSTRACT

A renewable power system is provided. The renewable power system includes a plurality of power generating devices and a plurality of power converters. Each power converter of the plurality of power converters is electrically coupled to at least one power generating device of the plurality of power generating devices and a load. The renewable power system further includes a plurality of controllers. Each of the plurality of controllers includes a processor coupled in communication with at least one power converter of the plurality of power converters. The processor is configured to detect a load power of the load, determine an available power of the plurality of power generating devices, and, in response to the load exceeding the available power of the plurality of power generating devices, adjust at least one parameter of the at least one power converter.

### STATEMENT REGARDING FEDERALLY SPONSORED RESEARCH AND DEVELOPMENT

This invention was made with Government support under contract number DE-EE0009024 awarded by the U.S. Department of Energy. The Government has certain rights in this invention.

### BACKGROUND

The field of the invention relates generally to control systems of power generation facilities, and more particularly, to overload control in renewable power generation facilities.

In certain renewable power systems, a grid may be formed by renewable power sources (e.g., photovoltaic (PV) sources, wind sources, and/or batteries) and power converters that convert renewable power provided by these sources to power suitable for supply to the grid, which in turn may be used to supply power to a load. Because the grid may not include traditional power sources in addition to the renewable sources, in order to achieve stability for the grid, these power converters must achieve a generation and load balance to ensure that the power supplied by the renewable sources meets the power demands of the load. If the power demand of the load exceeds the power generating capability of the renewable sources, the power converters may enter an unstable state resulting in loss of power at the load. For example, PV sources may experience voltage collapse during such overload conditions. A renewable power system having overload control for improved stability during overload conditions is therefore desirable.

### BRIEF DESCRIPTION

In one aspect, a renewable power system is provided. The renewable power system includes a plurality of power generating devices and a plurality of power converters. Each power converter of the plurality of power converters is electrically coupled to at least one power generating device of the plurality of power generating devices and at least one of a load and/or a main grid. The renewable power system further includes a plurality of controllers. Each of the plurality of controllers includes a processor coupled in communication with at least one power converter of the plurality of power converters. The processor is configured to detect a load power of the at least one of load and/or the main grid, determine an available power of the plurality of power generating devices, and, in response to the load power exceeding the available power of the plurality of power generating devices, adjust at least one parameter of the at least one power converter.

In another aspect, a method for controlling a renewable power system is provided. The renewable power system includes a plurality of power generating devices and a plurality of power converters. Each power converter of the plurality of power converters electrically coupled to at least one power generating device of the plurality of power generating devices and at least one of a load and/or a main grid. The renewable power system further includes a plurality of controllers. Each of the plurality of controllers includes a processor coupled in communication with at least one power converter of the plurality of power converters. The method includes detecting, by the processor, a load power of the at least one of the load and/or the main grid. The method further includes determining, by the processor, an available power of the plurality of power generating devices. The method further includes, in response to the load power exceeding the available power of the plurality of power generating devices, adjusting, by the processor, at least one parameter of the at least one power converter.

In another aspect, a controller for a power converter is provided. The power converter is electrically coupled to at least one power generating device of a plurality of power generating devices and at least one of a load and/or a main grid. The controller includes a processor coupled in communication with the power converter. The processor is configured to detect a load power of the at least one of the load and/or the main grid, determine an available power of the plurality of power generating devices, and, in response to the load power exceeding the available power of the plurality of power generating devices, adjust at least one parameter of the power converter.

### DRAWINGS

These and other features, aspects, and advantages of the present disclosure will become better understood when the following detailed description is read with reference to the accompanying drawings in which like characters represent like parts throughout the drawings, wherein:

FIG. 1 is a diagram of an example renewable power system.

FIG. 2 is a diagram of an example overload controller for use within the renewable power system shown in FIG. 1.

FIG. 3A is a graph representing a relationship between power and voltage for a power converter during an overload condition.

FIG. 3B is a graph representing a relationship between power and voltage for a power converter during an overload condition in which overload controlling is applied.

FIG. 4 is a diagram of another example renewable power system.

FIG. 5 is a flowchart of an example method for controlling a renewable power system.

FIG. 6 is a flowchart of another example method for controlling a renewable power system.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about,” “substantially,” and “approximately,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Embodiments of the present disclosure include a renewable power system. The renewable power system includes a plurality of power generating devices (sometimes referred to herein as “renewable power sources”). The renewable power system further includes a plurality of power converters (e.g., inverters and/or other types of power converter). Each power converter of the plurality of power converters is electrically coupled to at least one of the power generating devices and to a grid and/or a load via a unit transformer. The renewable power system further includes a plurality of controllers, each including a processor coupled in communication with at least one of the power converters. The processors are configured to detect a load power of the grid and/or load, to determine an available power of the plurality of power generating devices, and to make the power converter work standalone or automatically in parallel with the plurality of power converters by certain mechanisms, such as droop characteristics, to meet load demand. In response to the load power exceeding the available power of the plurality of power generating devices (i.e., an overload condition is present), the processor adjust a voltage of the at least one power converter to increase an available power and/or increase stability of the system. In some embodiments, other output parameters of the power converters may be adjusted such as, for example, frequency and/or phase angle.

In some embodiments, the power converters may communicate through a communication network such as a decentralized communication network, for example, to share information about power production availability, to coordinate power output to the grid, to coordinate transfer of power production among the renewable sources, and/or to share other information.

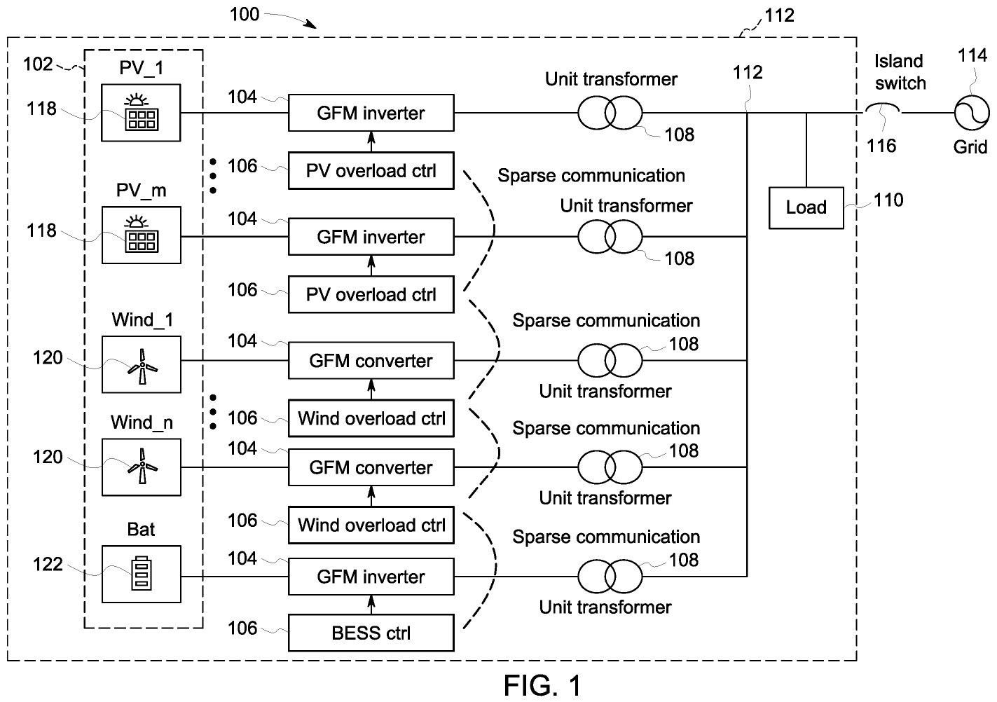

FIG. 1 illustrates an example renewable power system 100. Renewable power system 100 includes a plurality of renewable power sources 102, a plurality of power converters 104, a plurality of overload controllers 106, a plurality of unit transformers 108, and a load 110, which together form an island 112. The load 110 may be either a single load or a plurality of loads dispersed within island 112. In some embodiments, renewable power system 100 further includes a main grid 114 and an island switch 116 through which island 112 and main grid 114 may be electrically coupled and decoupled.

Renewable power sources 102 include, for example, photovoltaic (PV) sources 118, wind sources 120, and/or battery sources 122, each of which may produce, reserve, and/or store power that may be supplied to load 110 and/or main grid 114 via island grid 112. Each renewable power source 102 is electrically coupled to load 110 via one of power converters 104 and one of unit transformers 108, which together are configured to convert power produced by renewable power sources 102 to a type (e.g., a voltage and frequency) suitable for load 110 and/or main grid 114.

Each power converter 104 is coupled in communication with one of overload controllers 106, which forms a part of a converter controller. Overload controllers 106 are configured to detect a condition of island grid 112 in which power produced by renewable power sources 102 is less than power demanded by load 110 and/or grid 114, sometimes referred to herein as an “overload condition.” In response to determining an overload condition is present, as described in further detail below, overload controllers 106 are configured to control respective power converters 104 to reduce grid instability that may result from the overload condition.

To determine whether an overload condition is present, overload controllers 106 are configured to detect a load power of island grid 112 and/or the grid 114 and to determine an available power of renewable power sources 102. Each overload controller 106 may communicate with a respective power converter 104 and with one or more other overload controllers 106 to determine the total available power. As shown in FIG. 1, in some embodiments, certain overload controllers 106 may communicate directly with other overload controllers 106 through a decentralized communication network. In some such embodiments, the decentralized communication network may be “sparse,” in that any one overload controller may be connected directly to relatively few other overload controllers 106, while still being connected at least indirectly (e.g., through one or more other overload controllers 106) to each other overload controller 106 in the network. Within the decentralized network, one or more overload controllers 106 may be linked using any suitable wired or wireless communication mechanisms for transferring data therebetween. Additionally or alternatively, overload controllers 106 may communicate via a centralized network, for example, by communicating through a common network node, which may be implemented as a renewable power plant control device.

Overload controllers 106 are further configured to, in response to the load power exceeding the available power of renewable power sources 102, adjust commands of the power converters 104 based on the power difference. For example, one overload controller 106 may adjust a frequency reference of a corresponding power converter 104 by a selected amount determined by certain mechanisms, such as droop characteristics, that may increase the power output by power converter 104. Similarly, in some embodiments, overload controllers 106 are configured to, in response to the presence of the overload condition, adjust a voltage magnitude of the power converters 104 by a certain amount determined by certain mechanisms, such as droop characteristics, to decrease the load power demand for certain load types. Those skilled in the art will recognize that there may be different alternatives than those described herein that can achieve the same goal. For example, in some cases, adjusting only the frequency can increase the output power to balance the power demand, and in some cases, both the frequency and voltage magnitude need to be adjusted to achieve the power balance.

In some embodiments, overload controllers 106 utilize a dynamic boundary limits function to guarantee the availability of the renewable resources power in response to overload conditions. Overload controllers 106 may determine or estimate available power in real time, for example, based on measured data. Using the dynamic boundary limits function, overload controllers 106 may determine a range of operating points, such as PV voltage, for safe operation. Based on the determined range, overload controllers 106 are configured to determine an operating point for power converters 104 using an overload control function. For example, overload controllers 106 may select a voltage, frequency, phase angle, and/or other parameters under which to cause power converters 104 to operate that will increase and/or optimize output power without resulting in voltage collapse or other undesirable conditions. These parameters may be defined at least in part as a delta value with respect to a reference value. Examples may include (i) generating a frequency delta (i.e., a specified change in frequency) based on the power balance, (ii) generating a phase angle delta based on the power balance, (iii) generating a voltage magnitude delta based on the power balance, (iv) generating a voltage, frequency, and/or phase angle delta based on the magnitude and/or phase angle of current outputted by power converter 104, and/or (v) a voltage magnitude, frequency, and/or phase angle delta based on load information (e.g., feedback from island grid 112). In some embodiments, such delta values must fall within a certain pre-defined range (e.g., a range in which power converter 104 may stably operate and/or renewable power system 100 may satisfy grid code requirements).

In some embodiments, overload controllers 106 are further configured to determine a setpoint and/or control parameters for respective power converters 104 based on the available power of each of the plurality of power generating devices, which enables power production to be transferred, for example, from renewable power sources 102 having lesser available power to those having greater available power. By transferring power production as such, overload controllers 106 may further stabilize island 112 during overload conditions by reducing overloading on any given power converter 104. The transfer of power production may be coordinated by communication of overload controllers via any of the communication networks described above.

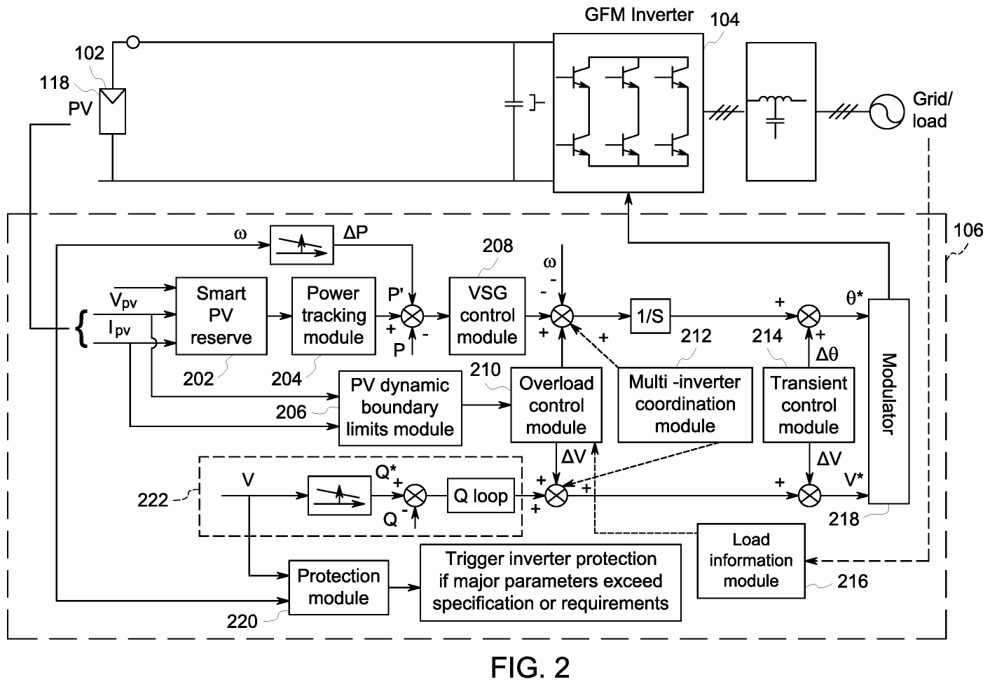

FIG. 2 is a diagram of an example overload controller 106. Overload controller 106 includes a smart PV reserve 202, a power tracking module 204, a PV dynamic boundary limits model 206, a virtual synchronous generator (VSG) control module 208, an overload control module 210, a multi-inverter coordination module 212, a transient control module 214, a load information module 216, a modulator 218, a protection module 220, and a Q/V control module 222, any of which may be implemented using hardware, software, and/or a combination thereof.

Smart PV reserve 202 and power tracking module are configured to determine a power output of renewable power source 102 based on, for example, a voltage, a current, and/or other detected parameters of renewable power source 102. In some embodiments, overload controller 106 includes and/or is coupled in communication with sensors for determining the voltage, current, and/or other parameters of renewable power source 102.

PV dynamic boundary limits model 206 is configured to determine, based on a boundary limits function and the determined power output of renewable power source 102, a range of voltage for safe operation, which may be used by overload controller 106 in determining operating parameters for power converter 104.

VSG control module 208 is configured to determine a frequency adjustment for controlling power converter 104 based on the determined power output of renewable power source 102. As described in further detail below, the frequency adjustment determined by VSG control module 208 may be further adjusted to account for overload conditions and/or other conditions.

Q/V control module 222 is configured to determine the magnitude control of the output voltage. In some embodiments, Q/V control module 222 may be configured as either Q mode, V mode, or droop mode based on different applications.

Overload control module 210 is configured to determine voltage, frequency, and other parameters under which to operate power converter 104 based on a determination that an overload condition is present and on the determined power output of renewable power source 102. Overload control module 210 may determine an overload condition is present based on information obtained from load information module 216, which is configured to obtain information about load 110 and/or grid.

Modulator 218 is configured to generate control signals (e.g., pulse width modulation (PWM) signals) for power converter 104 based on information received from VSG control module 208, overload control module 210, and or Q/V control module 222. In some embodiments, modulator 218 may further receive information, and generate the control signals further based on, information received from multi-inverter coordination module 212 (e.g., the control status of other power converters 104 and/or overload controllers 106) and/or transient control module 214 (e.g., to account for other transient factors). Protection module 220 is configured to trigger inverter protection (e.g., by deactivating power converter 104) if any detected parameters exceed a range and/or threshold of safe operation.

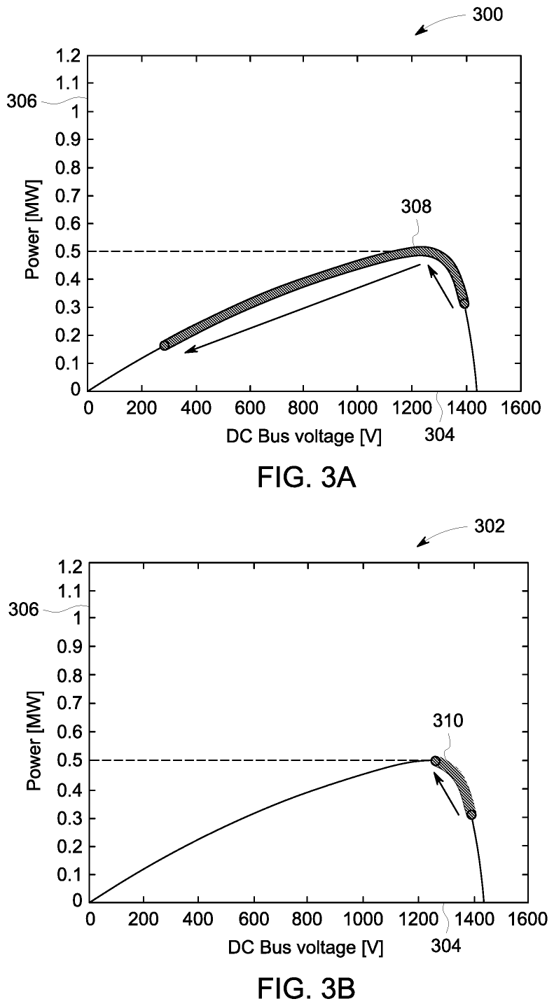

FIG. 3A depicts a graph 300, and FIG. 3B represents another graph 302. Graphs 300 and 302 each represent a power-voltage relationship at one of PV sources 118 (shown in FIG. 1), with graph 300 representing the power and voltage during a voltage collapse event, and graph 302 illustrating the power and voltage during overload control by overload controller 106 as described with respect to FIGS. 1 and 2. The two cases both assume that the PV inverter works in a power reserve mode (i.e., not at maximum power point) before the overload happens. Graphs 300 and 302 each include a horizontal axis 304, which represents direct current (DC) bus voltage expressed in volts, and a vertical axis 306, which represents power expressed in megawatts.

Graph 300 includes a power-voltage curve 308. As illustrated by power-voltage curve 308, without the overload control, the inverter controller will keep extracting more power to balance the load and generation power. Due to the non-linear power-voltage characteristic of PV sources, this may cause the DC bus voltage collapse, which may lead to system instability and exacerbate the whole system overload condition.

Graph 302 includes a power-voltage curve 310, corresponding to using overload control as described with respect to FIGS. 1 and 2. Overload control can still maintain a certain level of power output by adjusting the AC side voltage frequency and magnitude, together with the DC side dynamic boundary limiting. Although the operating point may still not meet the load power demand, at least it can avoid a voltage collapse and put the specific renewable source in a sub-optimal operation, contributing to the overall system stability and enabling other resources in island 112 to share loads.

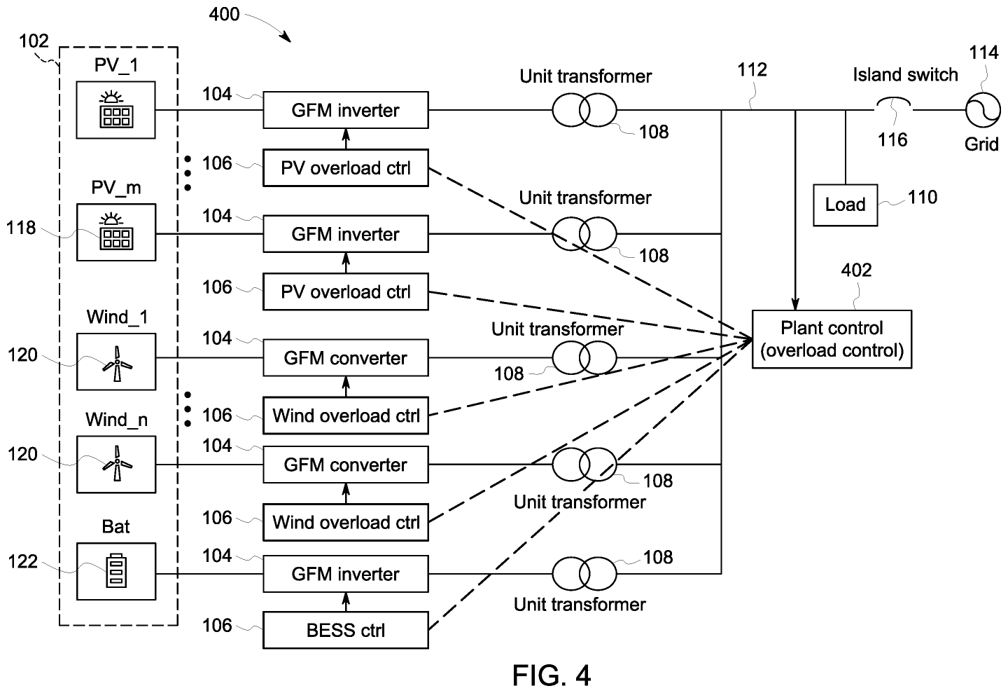

FIG. 4 illustrates an example renewable power system 400, which generally functions as described with respect to renewable power system 100 shown in FIG. 1. In addition to the components described with respect to renewable power system 100, renewable power system 400 includes a plant controller 402. Plant controller 402 is coupled in communication with each overload controller 106, and may facilitate a centralized communication network between the overload controllers 106. In some embodiments, some of the functions described with respect to overload controllers 106 may be performed by plant controller 402.

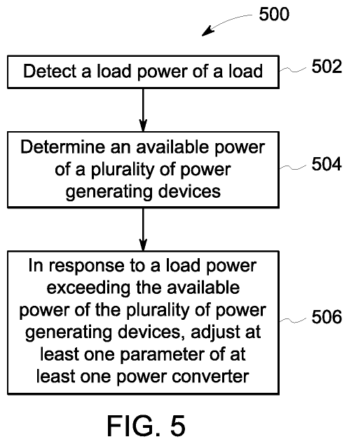

FIG. 5 is a flowchart illustrating an example method 500 for controlling a renewable power system (such as renewable power system 100) including a plurality of power generating devices (such as renewable power sources 102), a plurality of power converters (such as power converters 104), and a plurality of controllers (such as overload controllers 106). Each power converter is electrically coupled to at least one of the plurality of power generating devices and to a load (such as load 110) and/or grid (such as main grid 114), and each controller includes a processor coupled in communication with at least one of the plurality of power converters.

Method 500 includes detecting 502 a power of the load and/or the main grid.

Method 500 further includes determining 504 an available power of the plurality of power generating devices.

Method 500 further includes, in response to the load power exceeding the available power of the plurality of power generating devices, adjusting 506 at least one parameter of the at least one power converter.

In some embodiments, the renewable power system further includes a decentralized communication network, wherein the plurality of controllers are configured to communicate though the decentralized communication network. In some such embodiments, the decentralized communication network includes a sparse communication network.

In some embodiments, method 500 further includes adjusting the at least one parameter based on non-communication means such as droop characteristics to coordinate the plurality of power converters.

In some embodiments, method 500 further includes, in response to the load power exceeding the available power of the plurality of power generating devices, adjusting one or more of a frequency reference and/or a voltage magnitude of the at least one power converter.

In some embodiments, method 500 further includes determining a setpoint based on the available power of each of the plurality of power generating devices.

In some embodiments, method 500 further includes determining coefficients for power sharing based on the available power of each of the plurality of power generating devices.

In some embodiments, the renewable power system further includes an island switch (such as island switch 116) configured to selectively couple and decouple the island grid from a main grid.

In some embodiments, the renewable power system further includes a plurality of unit transformers (such as unit transformers 108), wherein each power converter of the plurality of power converters is coupled to the island grid via one of the plurality of unit transformers.

In some embodiments, wherein the plurality of power generating device includes one or more of a photovoltaic (PV) source (such as PV source 118), a wind source (such as wind source 120), and a battery source (such as battery source 122).

In some embodiments, the plurality of power converters includes at least one inverter.

In some embodiments, method 500 further includes determining a power setpoint based on the available power of each of the plurality of power generating devices.

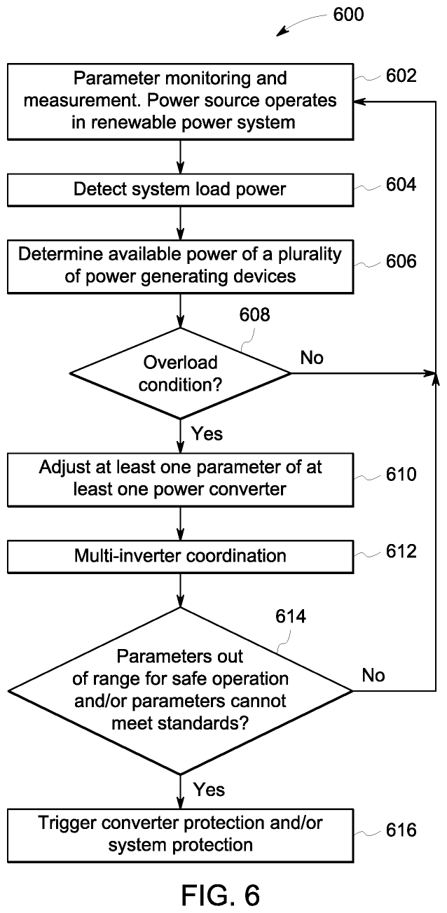

FIG. 6 is a flowchart illustrating an example method 600 for controlling a renewable power system (such as renewable power system 100). Method 600 includes operating 602 the renewable power system, detecting 604 a system load power, and determining an available power of a plurality of power generating devices (such as renewable power sources 102) of the renewable power system. Method 600 further includes determining 608 an overload condition is present. Method 600 further includes, if an overload condition is present, adjusting 610 at least one parameter of at least one power converter (such as power converters 104) of the renewable power system and coordinating 612 multiple inverters (e.g., of power converters 104) of the renewable power system. Method 600 further includes determining 614 parameters of the renewable power system are out of range for safe operation and/or are unable to meet required standards, and if so, triggering 616 converter protection and/or system protection (e.g., by deactivating power converter 104).

An example technical effect of the methods, systems, and apparatus described herein includes at least one of: (a) increasing output power during overload conditions in a renewable power system by releasing the reserved power in the plurality of power generating sources; (b) increasing system stability during overload conditions in a renewable power system by avoiding the collapse of DC bus voltage of plurality of inverters; (c) increasing system stability during overload conditions in a renewable power system by shifting power production within the system to renewable sources having a greater available power production; (d) increasing system stability during overload conditions in a renewable power system by adjusting power setpoint and coefficients for power sharing in at least one power generating source; (e) coordinating operation of power converters within a renewable power system during overload conditions using one or more of a decentralized and/or a centralized communication system.

Example embodiments of a renewable power system are provided herein. The systems and methods of operating and manufacturing such systems and devices are not limited to the specific embodiments described herein, but rather, components of systems and/or steps of the methods may be utilized independently and separately from other components and/or steps described herein. For example, the methods may also be used in combination with other electronic systems, and are not limited to practice with only the electronic systems, and methods as described herein. Rather, the example embodiments can be implemented and utilized in connection with many other electronic systems.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above embodiments are examples only, and thus are not intended to limit in any way the definition and/or meaning of the term processor and processing device.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A renewable power system comprising:
a plurality of power generating devices;
a plurality of power converters, each power converter of said plurality of power converters electrically coupled to at least one power generating device of said plurality of power generating devices and at least one of a load and/or a main grid; and
a plurality of controllers, each of said plurality of controllers comprising a processor coupled in communication with at least one power converter of said plurality of power converters, said processor configured to:
detect a load power of the at least one of the load and/or the main grid;
determine an available power of said plurality of power generating devices; and
in response to the load power exceeding the available power of said plurality of power generating devices, adjust at least one parameter of said at least one power converter.

2. The renewable power system of claim 1, further comprising a decentralized communication network, wherein said plurality of controllers are configured to communicate though said decentralized communication network.

3. The renewable power system of claim 1, wherein said processor of each of said plurality of controllers is configured to adjust the at least one parameter based on non-communication means to coordinate said plurality of power converters.

4. The renewable power system of claim 1, wherein in response to the load power exceeding the available power of said plurality of power generating devices, said processor is further configured to adjust one or more of a frequency reference and/or a voltage magnitude of said at least one power converter.

5. The renewable power system of claim 1, further comprising an island switch configured to selectively couple and decouple an island grid from the main grid.

6. The renewable power system of claim 1, further comprising a plurality of unit transformers, wherein each power converter of said plurality of power converters is coupled to an island grid via one of said plurality of unit transformers.

7. The renewable power system of claim 1, wherein each of said plurality of power generating devices comprises one or more of a photovoltaic (PV) source, a wind source, and a battery source.

8. The renewable power system of claim 1, wherein said plurality of power converters comprises at least one inverter.

9. The renewable power system of claim 1, wherein said processor of each of said plurality of controllers is further configured to determine a power setpoint based on the available power of each of said plurality of power generating devices.

10. A method for controlling a renewable power system including a plurality of power generating devices, a plurality of power converters, each power converter of the plurality of power converters electrically coupled to at least one power generating device of the plurality of power generating devices and at least one of a load and/or a main grid, and a plurality of controllers, each of the plurality of controllers including a processor coupled in communication with at least one power converter of the plurality of power converters, said method comprising:
detecting, by the processor, a load power of the at least one of the load and/or the main grid;
determining, by the processor, an available power of the plurality of power generating devices; and
in response to the load power exceeding the available power of the plurality of power generating devices, adjusting, by the processor, at least one parameter of the at least one power converter.

11. The method of claim 10, further comprising, in response to the load power exceeding the available power of the plurality of power generating devices, adjusting, by the processor, a frequency reference and/or a voltage magnitude of the at least one power converter.

12. The method of claim 10, further comprising determining, by the processor, a power setpoint based on the available power of each of the plurality of power generating devices.

13. The method of claim 10, further comprising determining, by the processor, coefficients for power sharing based on the available power of each of the plurality of power generating devices.

14. A controller for a power converter electrically coupled to at least one power generating device of a plurality of power generating devices and at least one of load and/or a main grid, said controller including a processor coupled in communication with the power converter, said processor configured to:
detect a load power of the at least one of the load and/or the main grid;
determine an available power of the plurality of power generating devices; and
in response to the load power exceeding the available power of the plurality of power generating devices, adjust at least one parameter of the power converter.

15. The controller of claim 14, wherein said controller is coupled to a plurality of controllers though a decentralized communication network.

16. The controller of claim 14, wherein said processor is configured to adjust the at least one parameter based on non-communication means.

17. The controller of claim 14, wherein in response to the load power exceeding the available power of the at least one power generating device, said processor is further configured to adjust one or more of a frequency reference and/or a voltage magnitude of the at least one power converter

18. The controller of claim 14, wherein the at least one power generating device includes one or more of a photovoltaic (PV) source, a wind source, and a battery source.

19. The controller of claim 14, wherein the power converter includes an inverter.

20. The controller of claim 14, wherein said processor is further configured to determine at least one of a power setpoint and/or coefficients for power sharing based on the available power of a plurality of power generating devices, the plurality of power generating devices including the at least one power generating device electrically coupled to the power converter.
